(19) United States
(12) Patent Application Publication
(10) Pub. No.: US 2010/0307176 A1
(43) Pub. Date: Dec. 9, 2010

(54) Water Cooled Condenser in a Vehicle HVAC System

(75) Inventors: Robert E. Zeweke, Shelby Township, MI (US); Brian V. Castillo, Royal Oak, MI (US); Gregory A. Major, Farmington Hills, MI (US); Roy D. Rodgers, Shelby Twp., MI (US); Paul R. Nahra, Shelby Township, MI (US); George M. Claypole, Fenton, MI (US)

Correspondence Address: MacMillan, Sobanski & Todd, LLC;One Maritime Plaza, 720 Water Street, 5th Floor, Toledo, OH, 43604, US

(73) Assignee: GM GLOBAL TECHNOLOGY OPERATIONS, INC., Detroit, MI (US)

(21) Appl. No.: 12/477,234

(22) Filed: Jun. 3, 2009

(51) Int. Cl. B60H 1/32; F25B 1/00

(52) U.S. Cl. 62/115; 62/506

(57) ABSTRACT

An HVAC system for use in a vehicle. The HVAC system comprises an evaporator, a refrigerant compressor that receives a refrigerant from the evaporator and compresses the refrigerant, a condenser that receives the refrigerant from the compressor and has fins with air flowing through the fins to remove heat from a refrigerant flowing through the condenser, and an expansion device that receives the refrigerant from the condenser and directs the refrigerant to the evaporator. The HVAC system also comprises a water tank that receives and stores water, a water spray pump that receives water from the water tank, and a nozzle that receives water from the water spray pump and is located adjacent to the condenser, with the nozzle selectively spraying water on the fins of the condenser.

### BACKGROUND OF INVENTION

The present invention relates generally to heating, ventilation and air conditioning (HVAC) systems for use in vehicles, and more particularly to the air conditioning portion of the HVAC systems.

There is a significant drive to improve the fuel economy of automotive vehicles. One vehicle operation that reduces fuel economy is air conditioning because it consumes a significant amount of energy when operating. Typical HVAC systems have refrigerant compressors and condensers that are sized based on a peak operating condition. The peak operating condition is typically employed during the first five minutes or so after initial vehicle start-up on a hot day. After the vehicle interior is cooled somewhat, the peak operating condition is no longer needed, so the HVAC system operates at lower steady-state conditions, which require much less HVAC system output. Consequently, the vehicles carry extra mass, cost and packaging penalties in the HVAC system even though the HVAC system may operate at peak capacity a small percentage of the time. Thus, it is desirable to provide an air conditioning system for a vehicle that provides adequate cooling performance for vehicle occupants, and operates as efficiently as is practicable while minimizing the cost, mass and packaging space of the air conditioning system.

### SUMMARY OF INVENTION

An embodiment contemplates an HVAC system for use in a vehicle. The HVAC system may comprise an evaporator, a refrigerant compressor that receives a refrigerant from the evaporator and compresses the refrigerant, a condenser that receives the refrigerant from the compressor and has fins with air flowing through the fins to remove heat from a refrigerant flowing through the condenser, and an expansion device that receives the refrigerant from the condenser and directs the refrigerant to the evaporator. The HVAC system also comprises a water tank that receives and stores water, a water spray pump that receives water from the water tank, and a nozzle that receives water from the water spray pump and is located adjacent to the condenser, with the nozzle configured to spray water on the fins of the condenser.

An embodiment contemplates a method of operating an HVAC system in a vehicle, the method comprising the steps of: directing a refrigerant through an expansion device to lower the temperature of the refrigerant before directing the refrigerant to an evaporator; directing air and the refrigerant through the evaporator to thereby cause the refrigerant to absorb heat from the air; compressing the refrigerant after the refrigerant flows from the evaporator and before the refrigerant flows through a condenser; directing the refrigerant through the condenser while drawing air through the condenser to thereby cause the air to absorb heat from the refrigerant; providing water in a water tank; and selectively spraying water from the water tank onto the condenser to thereby cause the water to absorb heat from the refrigerant flowing through the condenser.

An advantage of an embodiment is that an air conditioning portion of a vehicle HVAC system may operate more efficiently by spraying water onto a condenser to increase the refrigerant cooling capability of the condenser. Peak operating capacity is enabled for short periods via water vaporization on condenser. Moreover, chilled water that otherwise may be dumped onto the ground may be used for cooling. This may lower the peak HVAC system power requirements by increasing the overall HVAC system efficiency, all while maintaining desired cabin cooling performance. The compressor and condenser may be sized smaller than conventional ones would be based on closer to steady-state operating conditions (even during peak loads). Such an HVAC system may also allow for a reduced size for some of the HVAC system components, and possibly result in lower overall mass and improved system packaging. The lower overall mass may improve vehicle fuel economy.

### BRIEF DESCRIPTION OF DRAWINGS

FIG. 1 is a schematic diagram of a vehicle and a portion of an HVAC system used in the vehicle.

FIG. 2 is a schematic perspective view of a portion of the HVAC system of FIG. 1.

FIG. 3 is a schematic view similar to FIG. 1, but illustrating a second embodiment.

### DETAILED DESCRIPTION

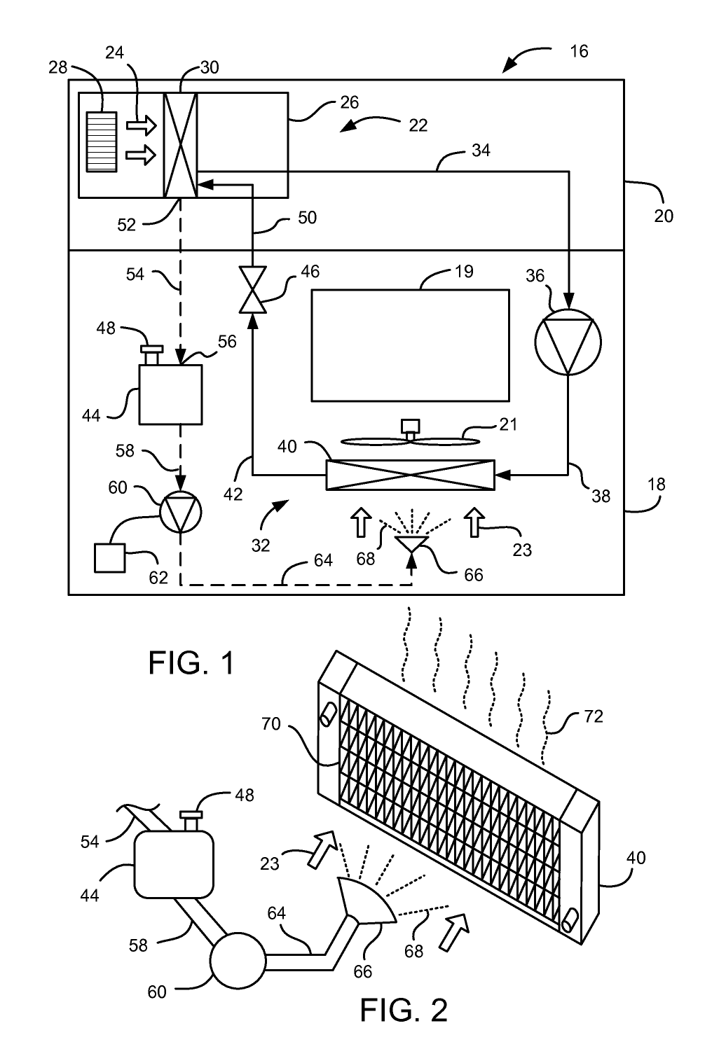

FIGS. 1 and 2 illustrate portions of a vehicle 16 and an HVAC system 22. The vehicle 16 may include an engine compartment 18 and a passenger compartment 20. The engine compartment 20 may contain a power plant 19, such as, for example, an internal combustion engine, and an engine cooling fan 21. The engine cooling fan 21 may be employed to draw air (indicated by large arrows 23) through a condenser 40 (discussed below).

The HVAC system 22 may include an HVAC module 26 (a portion of which is shown), which may include a blower 28 for forcing air (indicated by large arrows 24 in FIG. 1) through the HVAC module 26 and an evaporator 30, which receives cooled refrigerant from a refrigerant portion 32 of the HVAC system 22.

The refrigerant portion 32 of the HVAC system 22 also includes a compressor 36, a refrigerant line 34 that directs refrigerant from the evaporator 30 to the compressor 36, the condenser 40, and a refrigerant line 38 that directs refrigerant from the compressor 36 to the condenser 40. The refrigerant portion 32 also includes an expansion device 46, a refrigerant line 42 that directs refrigerant from the condenser 40 to the expansion device 46, and a refrigerant line 50 that directs refrigerant from the expansion device 46 to the evaporator 30 to complete a refrigerant loop. The expansion device 46 may be, for example, a thermostatic expansion valve, an orifice tube, or a pressure regulator. The solid lines with arrows on the line ends in FIG. 1 indicate the flow of refrigerant through refrigerant lines, with the arrows indicating the direction of flow.

The evaporator 30 includes a drain 52. A condensate drain line 54 directs condensate from the drain 52 to an inlet 56 to a water tank 44. The dashed lines in FIG. 1 indicate the flow of water through water lines, with the arrows at the line ends indicating the direction of flow. The water tank 44 may be insulated to maintain the cool temperature of the condensate, if so desired. The water tank 44 may include a fill neck/cap 48 that allows one to add user supplied water to the tank 44. A water drain line 58 directs condensate from the water tank 44 to a water spray pump 60, which has an output connected to one or more water nozzles 66 via a water spray line 64. A controller 62, which may be an HVAC controller or other controller in the vehicle, controls the operation of the pump 60 and, of course, may control the compressor 36 and other components of the HVAC system 22. The pump 60 draws water from the tank 44 and pushes it out through the nozzle 66 as water spray 68 that is directed onto the fins 70 of the condenser 40. The water spray 68 is indicated by dotted lines.

The operation of the HVAC system 22 will now be discussed relative to FIGS. 1 and 2. When operating a vehicle in hot ambient conditions, the refrigerant portion 32 of the HVAC system 22 is used to cool the passenger compartment 20 of the vehicle 16. The compressor 36 is activated, compressing refrigerant and pushing it into the condenser 40. As air 23 flows through the condenser 40, heat is removed from the refrigerant, which changes phase from a vapor to a liquid. The liquid refrigerant, at high pressure, then flows through the expansion device 46. The expansion device 46 causes the pressure and temperature of the refrigerant to drop, and the refrigerant is then directed through the evaporator 30.

Air flow 24 through the evaporator 30, forced through by the blower 28, is conditioned for both temperature and humidity. That is, as the air flows through the evaporator 30, the refrigerant flowing through the evaporator absorbs heat from the air—the air temperature is lowered below its dew point, causing moisture in the air to condense out. This condensate produced by the evaporator 30 is collected and directed from the drain 52 through the condensate drain line 54 into the water tank 44. The air flowing through the evaporator 30 is then directed into the passenger compartment 20.

There may be circumstances where the air conditioning load is quite high, such as, for example, at vehicle startup on a hot day with the vehicle parked in the sun. Under these types of circumstances, above a predetermined threshold where peak HVAC system performance is needed, as the compressor 36 is activated, the controller 62 may also activate the water spray pump 60. The water in the tank 44, then, will be sprayed from the nozzle 66 onto the condenser fins 70. As the water spray 68 hits the hot condenser fins 70, it will absorb heat from the refrigerant flowing through the condenser. Much of the water spray 68 may evaporate, turning into steam 72 (indicated by wavy dotted lines in FIG. 2). This water spray 68, undergoing a phase change, will absorb significant amounts of heat (in addition to the air flow 23 through the condenser 40), thus significantly increasing the heat removing capability of the condenser 40. After the peak HVAC need is met (i.e., after the passenger compartment 20 has cooled down somewhat), the water spray pump 60 may be deactivated since the air flow 23 through the condenser 40 is now sufficient to meet the cooling needs of the HVAC system 22.

Consequently, the condenser 40 may be smaller than otherwise needed for a conventional HVAC system in the same vehicle. Moreover, since the water spray 68 is only needed during peak loads, sufficient water can be stored in the tank 44 without requiring a prohibitively large tank 44.

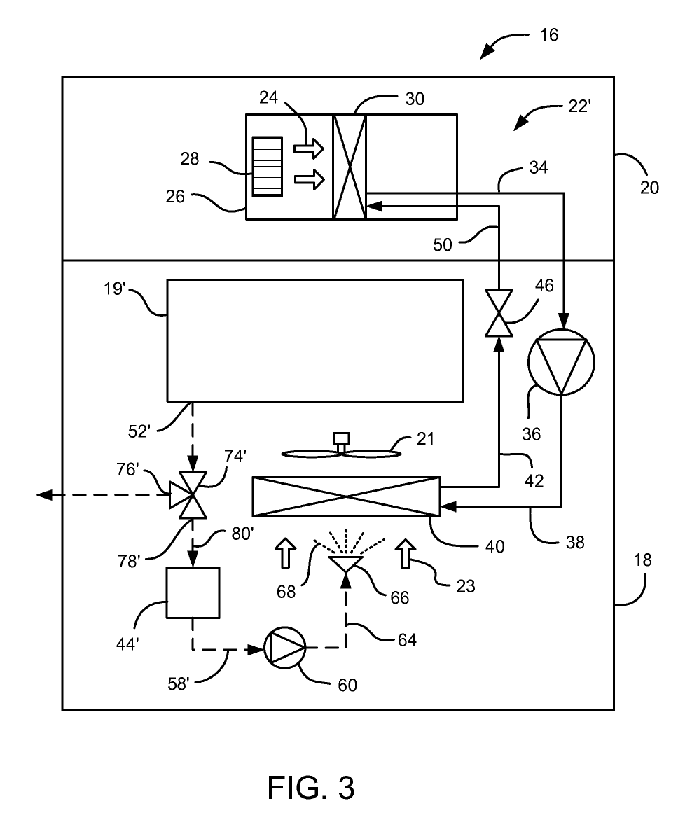

FIG. 3 illustrates portions of a vehicle 16 and an HVAC system 22′ according to a second embodiment. Since the system described in this embodiment is a modification of the first embodiment, like reference numerals designate corresponding parts in the drawings and detailed description thereof will be omitted, while elements that have changed or are new will have an added prime.

In this embodiment, the power plant being employed is a fuel cell 19′. One of the byproducts of fuel cell operation is water. Thus, a drain 52′ from the fuel cell 19′ connects to a bypass valve 74′ via a drain line 54′. The bypass valve 74′ may have a first output 76′ to atmosphere and a second output 78′ directing water, via a water line 80′, to a water tank 44′. The water tank 44′, in turn, is connected to the water spray pump 60 via a water line 58′. The water spray pump 60 still directs the water to a nozzle 66 that directs spray onto a condenser 40. Accordingly, the source of water for the tank 44′ is now the fuel cell 19′ rather than the evaporator 30. Otherwise the system essentially operates the same as in the first embodiment.

Alternatively, the HVAC system 22′ of FIG. 3 may also allow for condensate to drain from the evaporator into the water tank and for the tank to have a fill cap, if so desired. As another alternative, the bypass valve may be eliminated and an overflow valve (not shown) added to the water tank so that, when the tank is full, the additional water will just run out on the ground.

While certain embodiments of the present invention have been described in detail, those familiar with the art to which this invention relates will recognize various alternative designs and embodiments for practicing the invention as defined by the following claims.

What is claimed is:

1. An HVAC system for use in a vehicle comprising:
an evaporator;
a refrigerant compressor configured to receive a refrigerant from the evaporator and compresses the refrigerant;
a condenser configured to receive the refrigerant from the compressor and having fins configured to have air flow therethrough to remove heat from a refrigerant flowing through the condenser;
an expansion device configured to receive the refrigerant from the condenser and direct the refrigerant to the evaporator;
a water tank configured to receive and store water therein;
a water spray pump configured to receive water from the water tank; and
a nozzle configured to receive water from the water spray pump, the nozzle being located adjacent to the condenser and oriented to spray water on the fins of the condenser.

2. The HVAC system of claim 1 wherein the evaporator includes a drain configured to receive condensate that drips from the evaporator, and a condensate drain line configured to direct condensate from the drain into the water tank.

3. The HVAC system of claim 1 wherein the water tank has a fill neck and cap configured to allow operator pouring of water into the water tank.

4. The HVAC system of claim 1 including an HVAC controller and wherein the water spray pump is electrically driven and is activated and deactivated by the HVAC controller.

5. The HVAC system of claim 1 including an engine cooling fan located adjacent to the condenser and configured to pull air through the fins of the condenser.

6. The HVAC system of claim 1 including a water outlet from a fuel cell and a condensate drain line configured to direct water produced in the fuel cell from the water outlet into the water tank.

7. The HVAC system of claim 6 including a bypass valve configured to selectively direct water from the water outlet into the water tank and from the outlet to atmosphere, bypassing the water tank.

8. A method of operating an HVAC system in a vehicle, the method comprising the steps of:
(a) directing a refrigerant through an expansion device to lower the temperature of the refrigerant before directing the refrigerant to an evaporator;
(b) directing air and the refrigerant through the evaporator to thereby cause the refrigerant to absorb heat from the air;
(c) compressing the refrigerant after the refrigerant flows from the evaporator and before the refrigerant flows through a condenser;
(d) directing the refrigerant through the condenser while drawing air through the condenser to thereby cause the air to absorb heat from the refrigerant;
(e) providing water in a water tank; and
(f) selectively spraying water from the water tank onto the condenser to thereby cause the water to absorb heat from the refrigerant flowing through the condenser.

9. The method of claim 8 wherein step (e) is further defined by collecting a condensate formed on the evaporator and directing the condensate into the water tank.

10. The method of claim 8 wherein step (e) is further defined by directing water produced during operation of a fuel cell into the water tank.

11. The method of claim 10 wherein step (e) is further defined by providing a bypass valve between a water outlet and the water tank and selectively switching the bypass valve to direct water into the water tank and switching the bypass valve to direct the water to atmosphere, bypassing the water tank.

12. The method of claim 8 wherein step (f) is further defined by activating a water spray pump to draw water from the water tank and direct the water through a nozzle that sprays the water onto the condenser.

13. The method of claim 12 wherein step (f) is further defined by activating the water spray pump when an amount of cooling required for a passenger compartment of the vehicle is above a predetermined threshold and deactivating the water spray pump when the amount of cooling required is below the predetermined threshold.

14. The method of claim 8 wherein step (d) is further defined by operating an engine fan to draw air through the condenser.

15. The method of claim 8 wherein step (e) is further defined by a user pouring water into the water tank.
